(19) United States
(12) Patent Application Publication
(10) Pub. No.: US 2026/0198429 A1
(43) Pub. Date: Jul. 16, 2026

(54) Biodegradable Algae-Plastic Flower Pot

(71) Applicant: Qingyang Luo, Fremont, CA (US)

(72) Inventor: Qingyang Luo, Fremont, CA (US)

(21) Appl. No.: 19/021,125

(22) Filed: Jan. 14, 2025

(51) Int. Cl. A01G 9/02; C08L 67/00

(52) U.S. Cl. CPC A01G 9/0291

(57) ABSTRACT

The algae-plastic flower pot is an innovative, eco-friendly product designed to decompose into fertilizer when buried in soil. Made from biodegradable polymers derived from microalgae, specifically Polyhydroxyalkanoates (PHA) and Poly (3-hydroxybutyrate-co-3-hydroxyvalerate) (PHBV), this pot utilizes sustainable process where microalgae convert sugar into polymers with the aid of microbial enzymes. PHBV, a variant of PHA, exhibits properties akin to conventional plastics, ensuring durability while remaining environmentally friendly. The pot is shaped through bacterial synthesis and, after its intended use, can be buried in soil, where a diverse community of microorganisms, including bacteria and fungi, initiates the decomposition process.

This breakdown releases essential nutrients back into the soil, enhancing plant health. Additionally, the pot can be infused with micronutrients, such as ammonium salts or chelated zinc, to provide targeted nutrition for specific plants, promoting optimal growth. This design reduces plastic waste but also enriches the soil, supporting sustainable gardening practices.

### FIELD OF INVENTION

The present invention relates to biodegradable materials, biotechnology, and sustainable agriculture. Specifically, it pertains to the development of biodegradable plastics from renewable resources. The invention combines biotechnology, polymer science, and horticulture to create a novel flower pot.

### BACKGROUND OF INVENTION

The increasing environmental concerns surrounding plastic waste have prompted the need for sustainable alternatives in various industries, including horticulture. Traditional plastic flower pots contribute significantly to landfill waste, as they are often non-biodegradable and persist in the environment for hundreds of years. This invention addresses these challenges by introducing an innovative flower pot made from biodegradable polymers derived from microalgae. The flower pot is crafted from Polyhydroxyalkanoates (PHA) and Poly(3-hydroxybutyrate-co-3-hydroxyvalerate) (PHBV), both of which are produced through a natural process where microalgae consume sugar. Utilizing enzymes from microorganisms, these algae convert sugars into PHA and PHBV, which exhibit properties similar to conventional plastics, ensuring durability while remaining eco-friendly. The bacterial synthesis process allows for the transformation of these polymers into a functional flower pot that meets the needs of both consumers and the environment. Upon the end of its lifecycle, the pot can be buried in soil, where it undergoes decomposition facilitated by a diverse community of microorganisms, including bacteria and fungi. This process not only eliminates plastic waste but also enriches the soil by releasing essential nutrients. To further enhance the pot's benefits, micronutrients such as ammonium salts or chelated zinc can be integrated into the material, providing targeted nutrition to specific plants and promoting healthy growth. This invention represents a significant advancement in sustainable gardening practices, offering a practical solution to the plastic waste crisis while simultaneously supporting plant health and soil fertility. By leveraging the natural capabilities of microalgae and biodegradable polymers, this flower pot exemplifies a harmonious relationship between technology and nature.

### SUMMARY OF INVENTION

The invention pertains to an innovative flower pot made from biodegradable polymers derived from microalgae, specifically Polyhydroxyalkanoates (PHA) and Poly(3-hydroxybutyrate-co-3-hydroxyvalerate) (PHBV). These polymers are produced through a natural process in which microalgae consume sugar and, with the assistance of enzymes from microorganisms, convert it into PHA and PHBV. The resulting materials exhibit properties comparable to conventional plastics, making them suitable for durable and eco-friendly products. The biodegradable polymers are processed through bacterial synthesis to form the final flower pot. Once the pot has fulfilled its purpose, it can be buried in soil, where a diverse community of microorganisms, including bacteria and fungi, will initiate the decomposition process.

This breakdown of the pot releases valuable nutrients back into the soil, enriching it and supporting plant health. To enhance the pot's contribution to plant growth, essential micronutrients, such as ammonium salts or chelated zinc, can be incorporated into the material. This feature allows for targeted nutrition tailored to specific plant types, promoting optimal growth and health. Overall this algae-plastic flower pot represents a sustainable solution to plastic waste in horticulture, providing an environmentally friendly alternative that not only reduces landfill contributions but also enriches the soil, fostering a healthier ecosystem for plants.

### DETAILED DESCRIPTION OF INVENTION

The biodegradable algae-plastic flower pot is crafted from microalgae-derived biodegradable polymers, specifically Polyhydroxyalkanoates (PHA) and Poly(3-hydroxybutyrate-co-3-hydroxyvalerate) (PHBV). These polymers are produced through a process where microalgae consume sugar and convert it into PHA and PHBV with the help of microbial enzymes. The resulting PHBV possesses similar properties to conventional plastics, making it suitable for creating durable yet eco-friendly products. The biodegradable polymers are then processed into plastic through bacterial synthesis and shaped into the final flower pot form. Key points of this invention are Biodegradable Material, the flower pot is made from microalgae-derived biodegradable polymers, specifically Polyhydroxyalkanoates (PHA) and Poly (3-hydroxybutyrate-co-3-hydroxyvalerate) (PHBV). Decomposition into Fertilizer, the pot decomposes into fertilizer when buried in the soil, releasing valuable nutrients. Microalgae-Based Production, the biodegradable polymers are produced through a process where microalgae consume sugar and convert it into PHA and PHBV with the help of microbial enzymes. Bacterial Synthesis, the polymers are processed into plastic through bacterial synthesis and shaped into the final flower pot form. Targeted Nutrition, the pot's material can be infused with essential micronutrients providing targeted nutrition for specific plant types. Eco-Friendly, the invention reduces plastic waste and promotes sustainable gardening practices. Durable, the pot is durable and suitable for creating eco-friendly products. Microorganism-Based Decomposition, a diverse community of microorganisms breaks down the polymers, releasing nutrients into the soil. In conclusion, this algae-plastic flower pot represents a significant advancement in sustainable horticultural practices. By utilizing biodegradable polymers derived from microalgae, the invention not only addresses the pressing issue of plastic waste but also contributes positively to soil health and plant growth. The ability of the pot to decompose into nutrient-rich fertilizer upon burial ensures that it serves a dual purpose as a functional planting container and as a source of essential nutrients for plants. Furthermore, the incorporation of targeted micronutrients enhances its effectiveness, making it adaptable to various plant species. This innovative solution exemplifies a harmonious integration of technology and nature, paving the way for a more sustainable future in gardening and landscaping. The invention stands to benefit both consumers and the environment, promoting eco-friendly practices in the cultivation of plants.

### DESCRIPTION OF DRAWINGS

FIGS. 1, 1 is showing pot body which is made from Algae Bio-degradable plastic which is crafted from microalgae that produce biodegradable polymers, specifically Polyhydroxyalkanoates (PHA) and Poly(3-hydro xybutyrate-co-3-hydroxyvalerate) (PHBV). 2, shows drainage holes in which excess water can flow out.

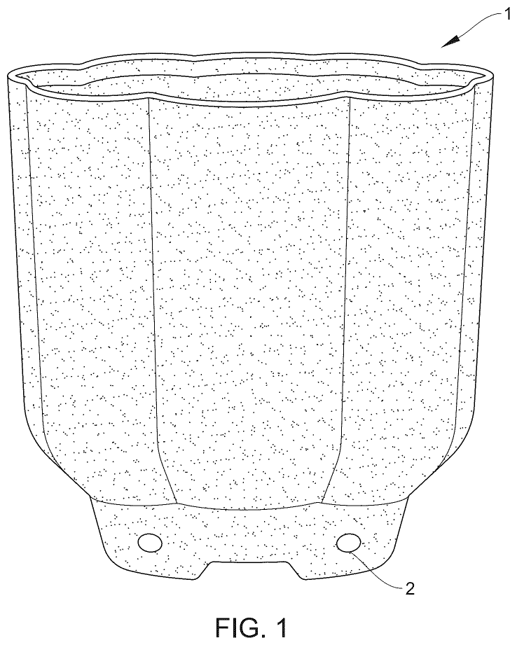

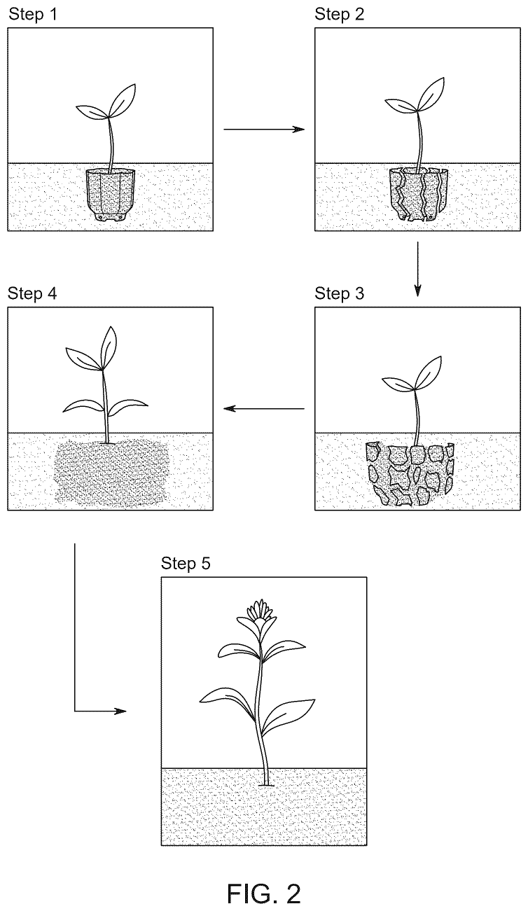

In FIG. 2, phase 1 shows plant is buried into the soil with the algae-based pot. Phase 2, shows the bacteria and fungi in the soil start to break down the pot. Phase 3, shows he bacteria and fungi break down the pot more, micronutrients are released into the soil. Phase 4, shows the pot fully decomposes and turned into organic matter, contributing to soil health. Phase 5, shows the end result, where the nutrients from the pot enrich the soil helping the plant continue to grow larger and healthier. The soil is more densely speckled with micronutrients.

What is claimed is,

1. A biodegradable flower pot comprising a polymer derived from microalgae, specifically Polyhydroxyalkanoates (PHA) and Poly(3-hydroxybutyrate-co-3-hydroxyvalerate) (PHBV), wherein the pot is designed to decompose into fertilizer when buried in soil.

2. The flower pot of claim 1, wherein the microalgae used for producing the biodegradable polymer includes, but is not limited to, Chlorella vulgaris and Spirulina platensis.

3. The flower pot of claim 1, wherein the biodegradable polymer exhibits properties similar to conventional plastics, allowing for durability while maintaining eco-friendliness.

4. The flower pot of claim 1, further comprising drainage holes to facilitate proper water drainage and aeration for plant roots.

5. The flower pot of claim 1, wherein the decomposition of the pot occurs within a time frame of approximately 2 to 3 months when buried in soil, facilitated by a diverse community of microorganisms including bacteria and fungi.

6. The flower pot of claim 1, wherein the microorganisms include Pseudomonas putida, Alloalcanivorax borkumensis, Aspergillus niger and Penicillium chrysogenum, which are commonly found in gardening soils.

7. The flower pot of claim 1, wherein the pot is embedded with essential micronutrients, such as ammonium salts or chelated zinc, to enhance soil fertility upon decomposition.

8. The flower pot of claim 1, wherein the micronutrients are distributed as specks within the pot body, providing targeted nutrition for specific plant types during the decomposition process.

9. The flower pot of claim 1, wherein the design and material composition of the pot promote healthy plant growth by improving soil conditions as the pot decomposes.

10. A method of using the biodegradable flower pot of claim 1, comprising the steps of planting a plant within the pot, allowing the pot to serve its purpose, and subsequently burying the pot in soil to facilitate its decomposition into fertilizer.
